(19) United States
(12) Patent Application Publication
(10) Pub. No.: US 2024/0079910 A1
(43) Pub. Date: Mar. 7, 2024

(54) WIRELESS-POWER TRANSMITTING DEVICE FOR CREATING A UNIFORM NEAR-FIELD CHARGING AREA

(71) Applicant: Energous Corporation, San Jose, CA (US)

(72) Inventors: Sohini SENGUPTA, Milpitas, CA (US); Yunhong LIU, San Jose, CA (US); Tuomo KATAJAMAKI, San Jose, CA (US)

(21) Appl. No.: 18/466,624

(22) Filed: Sep. 13, 2023

Related U.S. Application Data
(63) Continuation of application No. 17/228,621, filed on Apr. 12, 2021, now Pat. No. 11,799,324.
(60) Provisional application No. 63/009,361, filed on Apr. 13, 2020.

(51) Int. Cl. H02J 50/20; H02J 7/00; H02J 7/02; H02J 50/40

(52) U.S. Cl. CPC H02J 50/20; H02J 7/0042; H02J 7/02; H02J 50/402; H01Q 9/42

(57) ABSTRACT

An example near-field charging system includes a housing that includes a charging surface and at least one other surface, a radiating antenna, and a non-radiating element positioned above the radiating antenna within the housing such that the non-radiating element is closer to the charging surface than the radiating antenna. The radiating antenna produces a first electromagnetic-field distribution that is received by a receiver, the first electromagnetic-field provides usable power when the receiver is placed at any position on a first portion of the charging surface. The non-radiating element changes a distribution characteristic of the first electromagnetic-field distribution to produce a second electromagnetic-field distribution, the second electromagnetic-field distribution providing usable power to the receiver when the receiver is placed at any position across a second portion of the charging surface of the housing, and the second portion is at least 10% percent greater than the first portion.

This application is a continuation of U.S. patent application Ser. No. 17/228,621, filed on Apr. 12, 2021, entitled “Wireless-Power Transmitting Device For Creating A Uniform Near-Field Charging Area,” which claims priority to U.S. Provisional Application Ser. No. 63/009,361, filed Apr. 13, 2020, entitled “Wireless-Power Transmitting Device For Creating A Uniform Near-Field Charging Area,” each of which is herein fully incorporated by reference in its respective entirety.

### TECHNICAL FIELD

The present disclosure relates generally to wireless power transmission, and more particularly to radiating antennas (e.g., non-inductive, resonant near-field antennas coupled with a feed line) paired with non-radiating elements (e.g., elements not coupled with a feed line) for increasing the locations at which a receiver device can harness usable power on a charging surface.

### BACKGROUND

Portable electronic devices such as smartphones, tablets, notebooks, audio output devices and other electronic devices have become a necessity for communicating and interacting with others. The frequent use of portable electronic devices, however, requires a significant amount of power, which quickly depletes the batteries attached to these devices. Inductive charging pads and corresponding inductive coils in portable devices allow users to wirelessly charge a device by placing the device at a particular position on an inductive pad to allow for a contact-based charging of the device.

Conventional inductive charging pads, however, suffer from many drawbacks. For one, users typically must place their devices at a specific position and in a certain orientation on the charging pad because gaps (“dead zones” or “cold zones”) exist on the surface of the charging pad. In other words, for optimal charging, the coil in the charging pad needs to be aligned with the coil in the device in order for the required magnetic coupling to occur. Additionally, placement of other metallic objects near an inductive charging pad may interfere with operation of the inductive charging pad, so even if the user places their device at the exact right position, if another metal object is also on the pad, then magnetic coupling still may not occur and the device will not be charged by the inductive charging pad. This results in a frustrating experience for many users, as they may be unable to properly charge their devices. Also, inductive charging requires a relatively large receiver coil to be placed within a device to be charged, which is less than ideal for devices where internal space is at a premium.

Further, while near-field radio-frequency-based transmission techniques have also been explored, some of these techniques result in formation of charging areas that are insufficiently uniform to allow for a placing a device to-be-charge at any position on the charging surface.

### SUMMARY

Accordingly, there is a need for a near-field charging system that addresses the problems identified above. To this end, systems and methods described herein are capable of increasing the usable charging area on a charging surface, which allows users more flexibility to place their devices to be charged at various positions on the charging surface. In some embodiments, the usable charging area on the charging surface is improved by placing a non-radiating element between a charging surface and a radiating antenna.
(A1) In some embodiments, a near-field charging system comprising a housing is provided. The housing includes a charging surface and at least one other surface, a radiating antenna, and a non-radiating element positioned above the radiating antenna within the housing such that the non-radiating element is closer to the charging surface than the radiating antenna. The radiating antenna is configured to produce a first electromagnetic field distribution that is configured to be received by a wireless-power receiver placed on the charging surface of the housing, and the first electromagnetic field distribution is configured to provide at least 200 Milliwatts of usable power to the wireless-power receiver when the wireless-power receiver is placed at any position on a first portion of the charging surface of the housing. In addition, the non-radiating element is configured to change a distribution characteristic of the first electromagnetic field distribution to produce a second electromagnetic field distribution, and the second electromagnetic field distribution is configured to provide at least 200 milliwatts of usable power to the wireless-power receiver when the wireless-power receiver is placed at any position across a second portion of the charging surface of the housing. The second portion can be at least 10% percent greater than the first portion.
(A2) In some embodiments of the near-field charging system of A1, the second electromagnetic field distribution is configured to provide at least 220 Milliwatts of usable power to the wireless-power receiver when the wireless-power receiver is placed at any position across a second portion of the charging surface of the housing.
(A3) In some embodiments of the near-field charging system of A1, the second electromagnetic field distribution is configured to provide at least 1 watt of usable power to the wireless-power receiver when the wireless-power receiver is placed at any position across a second portion of the charging surface of the housing.
(A4) In some embodiments of the near-field charging system of A1, the second electromagnetic field distribution is configured to provide at least 5 watts of usable power to the wireless-power receiver when the wireless-power receiver is placed at any position across a second portion of the charging surface of the housing.
(A5) In some embodiments of the near-field charging system of A1, the first portion of the charging surface of the housing covers an area that includes 70% of the surface area of the charging surface.
(A6) In some embodiments of the near-field charging system of A1, the radiating antenna is configured to produce a first reflection coefficient, and positioning the non-radiating element above the radiating antenna within the housing such that the non-radiating element is closer to the charging surface than the radiating antenna, the radiating antenna is configured to produce a second reflection coefficient that is 12% less than the first reflection coefficient, thereby causing a reduction in return losses for the near-field charging system.
(A7) In some embodiments of the near-field charging system of A6, the second reflection coefficient varies between −13 dB and −16 dB.
(A8) In some embodiments of the near-field charging system of A6, the second reflection coefficient is less than −10 dB.
(A9) In some embodiments of the near-field charging system of A1, the second electromagnetic field distribution is configured to provide more than 200 Milliwatts of usable power to the wireless-power receiver at fewer locations on the charging surface of the housing relative to the first electromagnetic field distribution.
(A10) In some embodiments of the near-field charging system of A1, the charging surface has a depression configured to receive and partially house an audio output device. The wireless-power receiver can be coupled to the audio output device, and the wireless power receiver is configured to provide the at least 200 Milliwatts of usable power to the audio output device for charging or powering purposes.
(A11) In some embodiments of the near-field charging system of A10, the audio output device is a single in-ear audio output device.
(A12) In some embodiments of the near-field charging system of A1, the radiating antenna has a shape, and the radiating antenna is oriented to have a first orientation within the housing; and the non-radiating element has the shape and the first orientation within the housing.
(A13) In some embodiments of the near-field charging system of A1, the radiating antenna has a shape and the radiating antenna is oriented to have a first orientation within the housing; the non-radiating element has: the same shape; and a second orientation within the housing that is different from the first orientation.
(A14) In some embodiments of the near-field charging system of A1, the radiating antenna is connected to a power feed line, and the non-radiating element is not connected to a power feed line.
(A15) In some embodiments of the near-field charging system of A1, a non-conducting material is placed between the radiating antenna and the non-radiating element, wherein the non-conducting material electrically isolates the radiating antenna from the non-radiating element.
(A16) In some embodiments of the near-field charging system of A1, the radiating antenna and the non-radiating element both have a same radiating antenna design selected from the group consisting of: a PIFA antenna design, a patch antenna design, and a dipole antenna design.
(A17) In some embodiments of the near-field charging system of A1, the non-radiating element is positioned at least 1 millimeter above the radiating antenna within the housing such that the non-radiating element is closer to the charging surface than the radiating antenna.
(B1) In yet another aspect, a method of constructing a near-field charging system that increases usable wireless charging area available to a wireless-power receiver, the method comprising: providing a housing that includes a charging surface and at least one other surface a radiating antenna; placing a radiating antenna within the housing, the radiating antenna configured to produce a first electromagnetic field distribution that is configured to be received by a wireless-power receiver placed on the charging surface of the housing, the first electromagnetic field distribution is configured to provide at least 200 Milliwatts of usable power to the wireless-power receiver when the wireless-power receiver is placed at any position on a first portion of the charging surface of the housing; placing a non-radiating element in a position above the radiating antenna within the housing such that the non-radiating element is closer to the charging surface than the radiating antenna, wherein placing the non-radiating element in the position above the radiating antenna within the housing changes a distribution characteristic of the first electromagnetic field distribution to produce a second electromagnetic field distribution, the second electromagnetic field distribution is configured to provide at least 200 Milliwatts of usable power to the wireless-power receiver when the wireless-power receiver is placed at any position across a second portion of the charging surface of the housing, wherein the second portion is at least 10% percent greater than the first portion.
(B2) In some embodiments of the method of B1, additional constructing/producing steps are performed so that the resulting near-field charging system is in accordance with any one of A2-A18.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 shows a diagram of an example embodiment of a near field charging system for charging a pair of headphones or hearing aids.

FIG. 2 shows a diagram of an exploded view of a near field charging system for charging a pair of headphones or hearing aids, in accordance with some embodiments.

FIG. 3A shows an illustration of a electromagnetic field plot produced by a near field charging system, in accordance with some embodiments.

FIG. 3B shows an illustration of a electromagnetic field plot produced by a near field charging system, in accordance with some embodiments.

FIG. 4A shows an illustration of a electromagnetic field plot produced by a near field charging system when a non-radiating element has a first orientation.

FIG. 4B shows an illustration of a electromagnetic field plot produced by a near field charging system when a non-radiating element has a second orientation, in accordance with some embodiments.

FIGS. 5A-1 and 5A-2 show plots of the return loss when a non-radiating element is not added to the charging system, in accordance with some embodiments.

FIGS. 5B-1 and 5B-2 show plots of the return loss when a non-radiating element is added to the charging system, in accordance with some embodiments.

FIG. 6 is a block diagram of an RF wireless-power transmission system, in accordance with some embodiments.

FIG. 7 is a block diagram showing components of an example RF power transmission system that includes an RF power transmitter integrated circuit and antenna coverage areas, in accordance with some embodiments.

FIG. 8 is a flow diagram showing a method of constructing a near-field charging system, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

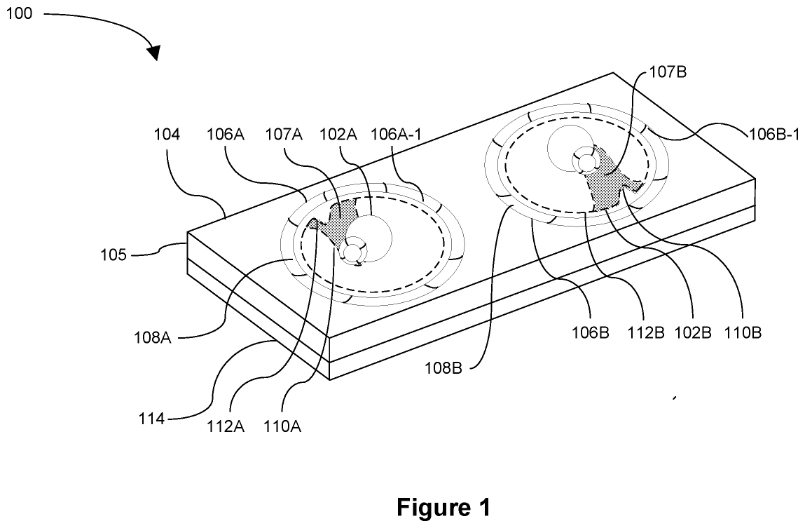

FIG. 1 shows an illustration of a representative near-field charging system 100 that is configured to charge an electronic device (e.g., headphones, cellphones, tablets, and/or other electronic devices) or a pair of associated electronic devices (e.g., a pair of earbuds, a pair of hearing aids, etc.). The design of a near-field charging system 100 is illustrated in a particular way for ease of illustration and one skilled in the art will appreciate that other designs are possible. For example, the overall size of the charging system 100 can be varied to be appropriate for the device(s) that is being charged.

As electronic devices shift to wireless designs (e.g., wireless audio output devices 102A and 102B, which in some embodiments are hearing aids, or earbuds) that require them to be charged daily, there has become a need for a convenient way to charge all these devices. Traditional methods have required specialized charging cases that require electronic devices to be oriented in a specific manner and placed at a specific position to receive power and get charged. Having a charging surface that can charge wireless devices without regard to the orientation of the wireless devices on the charging surface, similar to the near-field charging system 100 shown in FIG. 1, is highly convenient. Such an approach does not involve specialized cases, the user can simply place the devices they wish to be charged on the charging surface at any position and/or orientation, and not perform any additional action (e.g., the user could just drop the earbuds down on the charging surface).

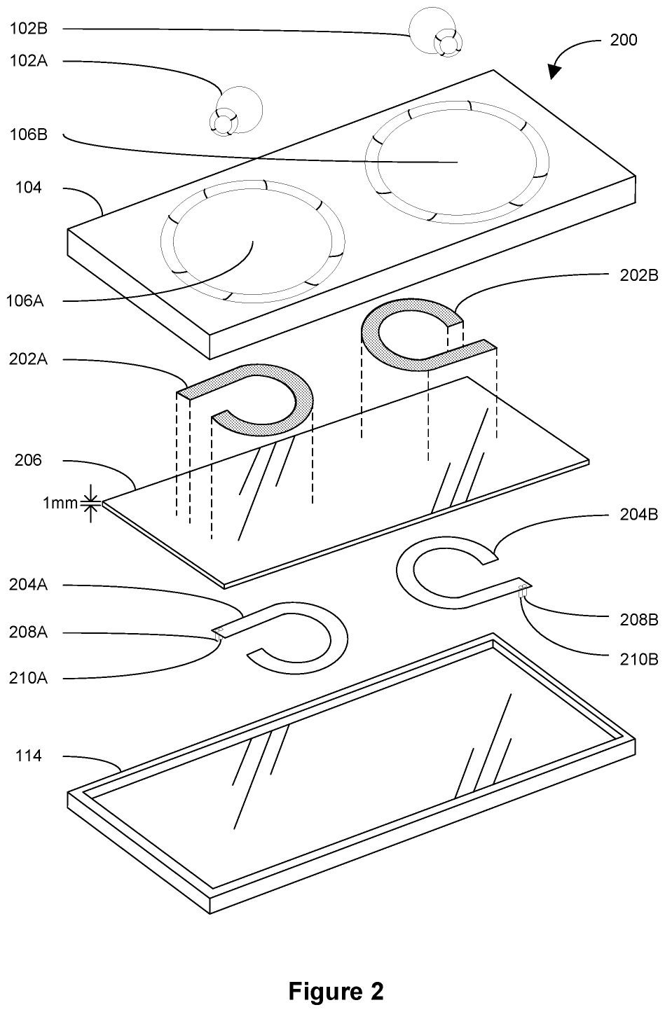

Specifically, FIG. 1 shows a representative near-field charging system that has a charging surface that can charge wireless devices (e.g., audio output devices 102A and 102B such as wireless earphones) without regard to the orientation of the wireless devices on the charging surface. Near-field charging system 100 in FIG. 1 includes a housing 104 that has multiple charging surfaces (e.g., charging surfaces 106A and 106B) disposed upon a top surface 105 of the housing 104. In this illustrated embodiment, charging surfaces 106A and 106B are indicated to the user by depressions 108A and 108B, respectively. Furthermore, the components under the charging surface (shown in FIG. 2) are configured to output enough Radio Frequency (RF) energy that when the RF energy is rectified by a receiving device (specific receiving device that is configured to receive 200 mW from the charging system), the receiving device receives 200 mW of usable power. It should also be appreciated that 200 mW is just one configuration to charge audio output devices 102A and 102B (e.g., headphones, earbuds, hearing aids, etc.,) and the usable power may be adjusted based on the different power-consumption demands of other electronic devices (e.g., 500 mW of usable power may be sufficient to charge a cellphone). In some embodiments, usable power is the power required to concurrently power or charge an electronic device that is in an active state (e.g., the electronic device is operating in a powered on state, and the device fully charges in a reasonable amount of time (e.g., 1 to 2 hours)). To illustrate the charging surfaces depressions 106A-1 and 106B-1 are shown to correspond with the charging surfaces 106A and 106B, respectively.

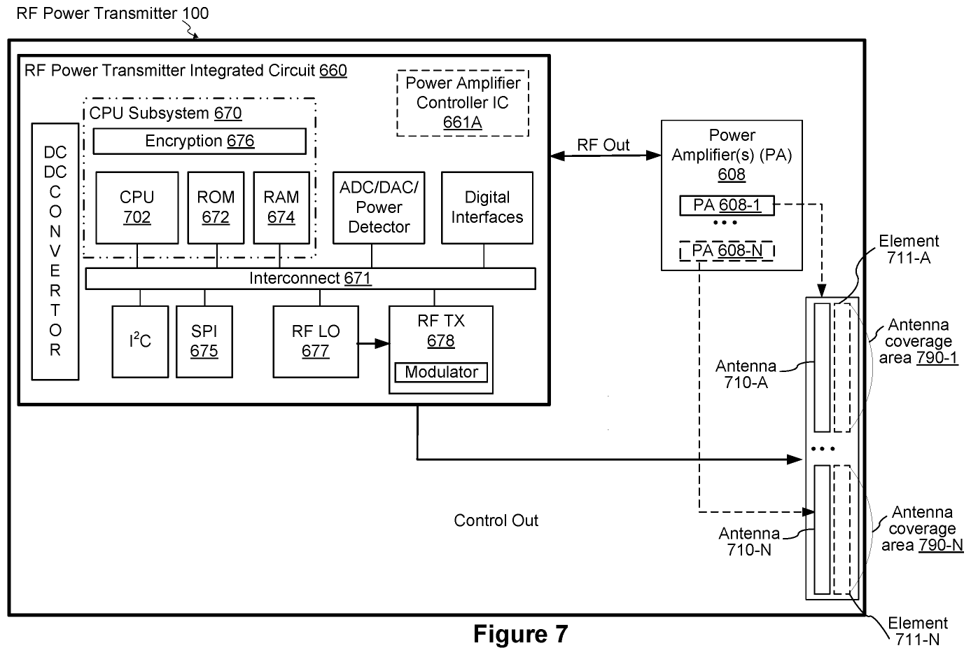

Although two charging surfaces are shown in a specific orientation, any orientation of charging surfaces is possible depending on the requirements of the electronic device(s). For example, in some embodiments, charging surfaces 106A and 106B can overlap or be perfectly adjacent to each other to make a continuous charging surface. FIG. 1 also shows two reduced-charging-areas 110A and 110B and two increased-charging-areas 112A and 112B. These two reduced-charging-areas 110A and 110B illustrate the reduced charging surface area that results if the housing 104 includes a radiating antenna and does not include a non-radiating element within the housing as well. The two increased-charging-areas 112A and 112B illustrate the increased charging surface area that results when a non-radiating elements 202A and 202B in FIG. 2 (which are analogous to elements 711-A-711-N in FIG. 7) are placed between radiating antennas 204A and 204B in FIG. 2 (which are analogous to Antennas 710-A-710-N in FIG. 7) and charging surfaces 106A and 106B, respectively. FIG. 1 also shows a bottom surface 114 of the housing 104, which helps contain the components described in FIG. 2. To further illustrate the increased charging area, the shaded regions 107A and 107B (e.g., dead zones) show the locations at which usable power is available as a result of adding the non-radiating elements. As illustrated by the shaded regions 107A and 107B, by positioning the non-radiating element 202A and 202B above the radiating elements 204A and 204B, the shaded regions (e.g., dead zones) now become a usable area for charging an electronic device, thereby making the overall charging area more uniform across the entirety of the charging surfaces 106.

FIG. 2 shows an exploded view 200 of a near-field charging system 100. As briefly described above, the inventive near-field charging system 100 produces a uniform charging surface with minimal dead spots. In some embodiments, this is achieved by causing a change to a radiating antenna's electromagnetic field (i.e., electric field distribution, magnetic field distribution, or current distribution) by placing a non-radiating element (e.g., a PIFA antenna design, a patch antenna design, and a dipole antenna design that are all electrically isolated from a power source) above the radiating antenna. Stated another way, the non-radiating element can change a distribution characteristic of the radiating element's electromagnetic field distribution to produce another electromagnetic field distribution that produces a uniform charging area across the charging surface.

Specifically, FIG. 2 shows components of a near-field charging system 100 capable of charging wireless audio output devices 102A and 102B. As shown in FIG. 2 (and as was also described above with reference to FIG. 1), a housing 104 has charging surfaces 106A and 106B. Beneath each of charging surfaces 106A and 106B is a non-radiating element (e.g., an element that is not connected to a power feed line or a ground line). The non-radiating elements are shown in FIG. 2 as 202A and 202B, and these non-radiating elements are placed below charging surfaces 106A and 106B, respectively, within the housing 104. In some embodiments, the non-radiating elements 202A and 202B can be printed on a top surface of a circuit board 206. In such embodiments, circuit board 206 can be made of a non-conducting material (e.g., a dielectric substrate or plastic) that electrically isolates non-radiating elements 202A and 202B from power sources and ground. To help encourage equal distribution of usable energy across charging surfaces 106A and 106B (when the radiating antennas 204A and 204B are radiating RF energy), the circuit board 206 should have a thickness of at least 1 millimeter to 5 millimeters.

FIG. 2 also shows two radiating antennas 204A and 204B placed (e.g., in some embodiments, printed) on the bottom side (i.e., opposite) of the circuit board 206 to electrically isolate radiating antennas 204A and 204B, which in some embodiments have a direct connection to the power source(s) and ground(s), from the non-radiating elements 202A and 202B. In the illustrated embodiment, non-radiating elements 202A and 202B have the same design, size, and orientation in the housing (housing 104) as radiating antennas 204A and 204B. A person of skill in the art, upon reading the present disclosure, will appreciate that the designs do not need to match, and even if the designs do match, they do not need to be the same size (e.g., the radiating antenna can be 1% smaller than the non-radiating element, or the radiating antenna can be 5% larger than the non-radiating element). Radiating antennas 204A and 204B are also connected to power feed lines 210A and 210B, respectively, and grounds 208A and 208B, respectively.

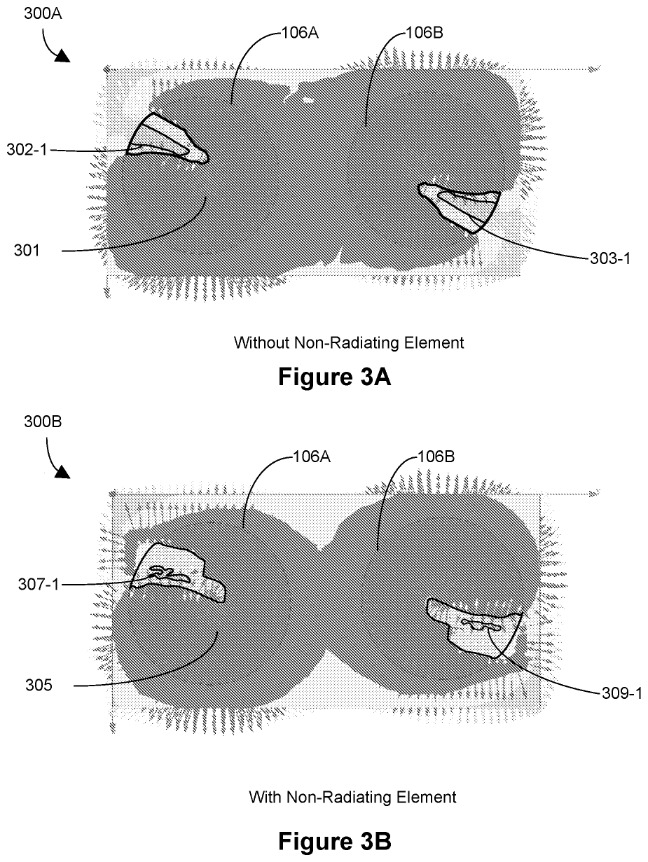

As discussed above, the radiating antennas 204A and 204B each produce a first electromagnetic field distribution when there is no non-radiating element positioned above the radiating antennas. This electromagnetic field distribution is shown in FIG. 3A, which shows a electric field distribution plot 300A on a two dimensional plane that is coplanar with charging surfaces 106A and 106B. The electromagnetic field plot 300A shows the electromagnetic field output by the radiating antennas 204A and 204B without having a non-radiating elements 202A and 202B placed in-between the radiating antennas 204A and 204B and the charging surfaces 106A and 106B. As shown in electromagnetic field plot 300A, cold zones (also referred to as dead zones) are present on the charging surfaces (e.g., for purposes of this disclosure, cold zones are areas on the charging surface at which a device to-be-charged would receive an insufficient amount of usable power to power the device or to provide enough power to charge a power source/battery of the device). Cold zones 302-1 and 303-1 indicate positions at which usable power can be improved. Due to presence of these cold zones, the usable charging area on the charging surfaces 106A and 106B can be said to be non-uniform.

To improve the uniformity of available usable power on the charging surfaces 106A and 106B, non-radiating elements 202A and 202B are placed between the radiating antennas 204A and 204B and the charging surfaces 106A and 106B, respectively Placement of the non-radiating elements 202A and 202B above the radiating elements 204A and 204B, respectively, causes a change in the electromagnetic field distributions produced, thereby causing the radiating elements to each produce a second (different) electromagnetic field distribution rather than the first electromagnetic field distribution discussed above. The resulting electric field distribution plot 300B (which corresponds to the second electromagnetic field distribution produced by each of the radiating elements) is shown in FIG. 3B. As illustrated, cold zones now occupy a far smaller area of each of the charging surfaces. In particular, cold zone 307-1 is significantly smaller than cold zone 302-1, and cold zone 309-1 is significantly smaller than cold zone 303-1. In some embodiments, each cold zones is reduced in size by approximately 80-90%.

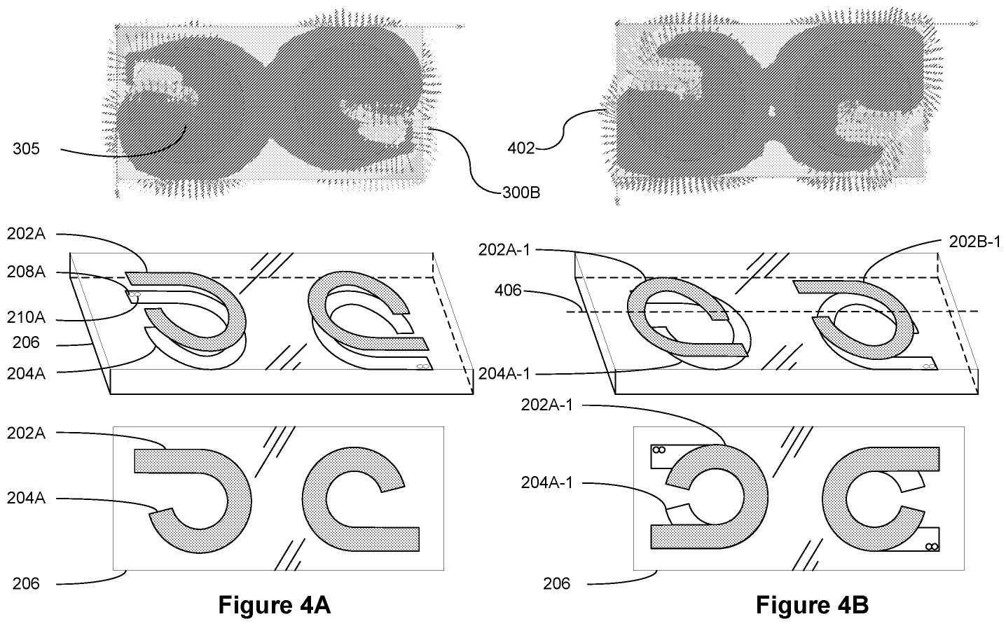

FIG. 4A shows the same resulting electromagnetic field plot 300B as shown in FIG. 3B. This electromagnetic field plot 300B, as discussed in relation with FIG. 3B shows that adding non-radiating elements 202A and 202B between the radiating antennas 204A and 204B and the charging surfaces 106A and 106B can increase the locations on charging surfaces 106A and 106B that have sufficient usable power (stated another way, and as discussed above, the size of a cold zone on each charging surface is reduced significantly). While one orientation of non-radiating elements 202A and 202B within the housing 104 is shown in FIGS. 2 and 4A, other possible orientations of non-radiating elements 202A and 202B within the housing 104 are possible. Changes in orientation of the non-radiating elements 202A and 202B can change the resulting electromagnetic field distribution produced by the corresponding radiating elements in the presence of the non-radiating elements.

For example, FIG. 4B shows another possible orientation of non-radiating elements, one in which non-radiating elements 202A and 202B are flipped about horizontal axis 406 (stated another way, the non-radiating elements are rotated 180 degrees relative to the orientation of the non-radiating elements in FIG. 4A). These flipped/rotated non-radiating elements are shown in FIG. 4B as flipped-non-radiating elements 202A-1 and 202B-1. FIG. 4B also shows the resulting electromagnetic field plot 402 produced by this combination of flipped-non-radiating elements 202A-1 and 202B-1 and radiating elements 204A and 204B, which illustrates how the electromagnetic field distributions produced by the radiating elements are altered in response to flipping of the orientations of the non-radiating elements 202A and 202B. In some embodiments, one of the reasons why the non-radiating elements results in a more uniform charging surface is that the non-radiating elements stabilize the return loss for the charging system 100 and additionally keeps the return loss lower. In some embodiments, a low and stable return loss ensures that maximum power is transmitted via the charging system 100 and made available at the charging surfaces 106A and 106B. In some embodiments, without the non-radiating elements, the radiating antennas 204A and 204B would have a return loss that fluctuates as the location of the audio output devices 102A and 102B changes on the charging surfaces. In some embodiments, when the return loss is high, not enough power is available for charging the electronic devices.

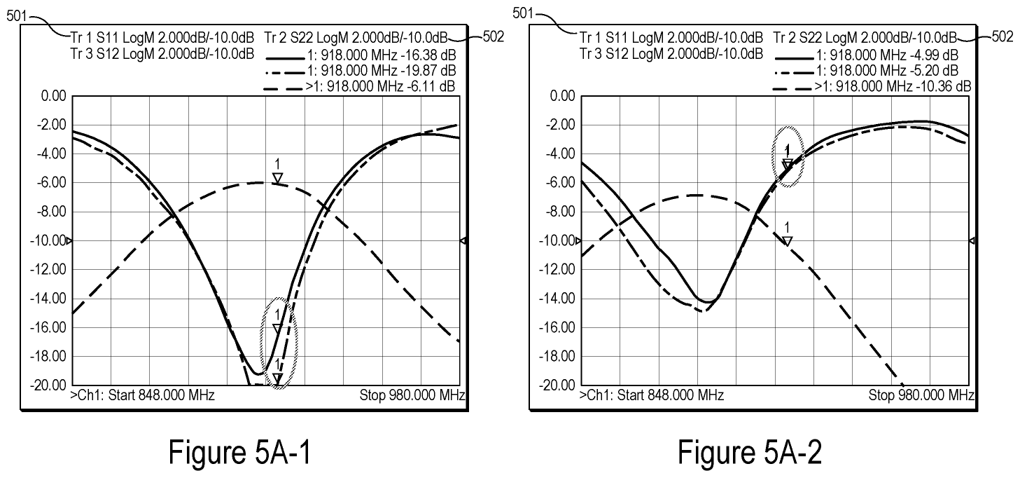

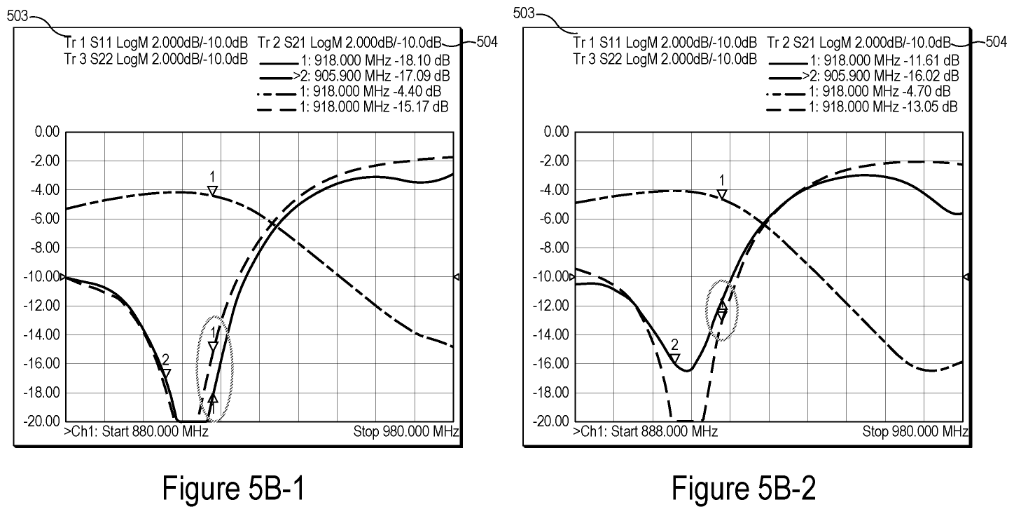

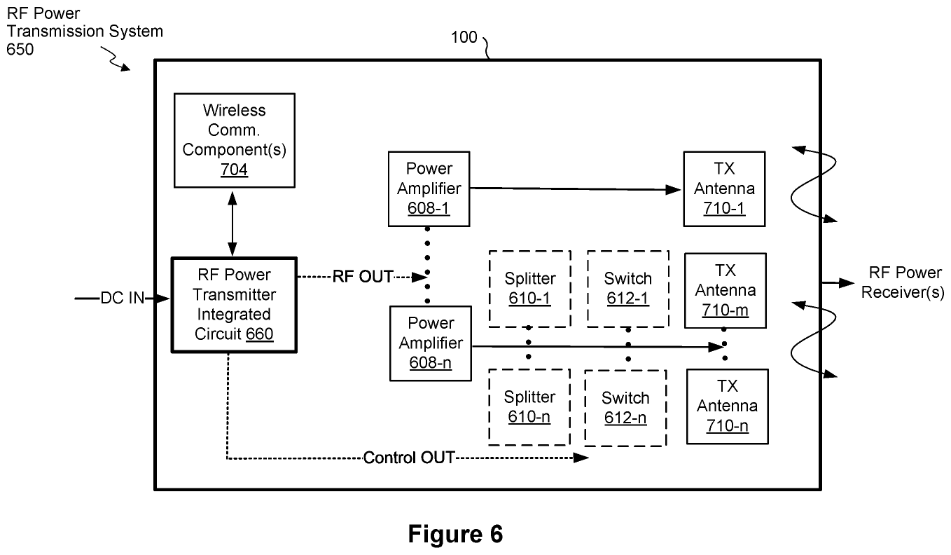

FIGS. 5A-1, 5A-2, 5B-1, and 5B-2 show plots of return losses, which show that adding non-radiating elements 202A and 202B between the radiating antennas 204A and 204B and the charging surfaces 106A and 106B can reduce the amount of irregular variation in return loss at the near-field charging system 100 as the location of the audio output devices 102A and 102B is varied. FIGS. 5A-1 and 5A-2 illustrate the wireless charger transmitter system without the non-radiating elements 202A and 202B (e.g., parasitic elements). FIGS. 5A-1 and 5A-2 show a large variation in the reflection coefficient. In FIGS. 5A-1 and 5A-2 “S11” and “S22” indicated by 501 and 502, respectively, indicate the reflection coefficients corresponding to the two radiating elements. The plots in FIGS. 5A-1 and 5A-2 show the reflection coefficients as the audio output devices 102A and 102B (e.g., two earbuds) are placed at different locations across the charging surfaces. FIG. 5A-1 shows that in some embodiments, the best case for reflection coefficient is: S11=−16.38 dB, S22=−19.87 dB. FIG. 5A-2 shows that in some embodiments, the worst case for reflection coefficient: S11=−4.99 dB, S22=−5.20 dB.

In contrast to FIGS. 5A-1 and 5A-2, FIGS. 5B-1 and 5B-2 illustrate the wireless charger transmitter system with the non-radiating elements 202A and 202B (e.g., parasitic elements). FIGS. 5B-1 and 5B-2 show a small variation in the reflection coefficient. In FIGS. 5B-1 and 5B-2 “S11” and “S22” indicated by 503 and 504, respectively, indicate the reflection coefficients corresponding to the two radiating elements. The plots in FIGS. 5B-1 and 5B-2 show the reflection coefficients as the audio output devices 102A and 102B (e.g., two earbuds) are placed at different locations across the charging surfaces. FIG. 5B-1 shows that in some embodiments, the best case for reflection coefficient is: S11=−18.10 dB, S22=−15.17 dB. FIG. 5B-2 shows that in some embodiments, the worst case for reflection coefficient: S11=−11.61 dB, S22=−13.05 dB.

While the above descriptions focused on the radiating and non-radiating elements of the inventive near-field charging system 100 for illustrative purposes, one of skill in the art will also appreciate that additional components are used to safely control the transmission of wireless power by the near-field charging system 100. For instance, additional components of the near-field charging system 100 are shown in FIG. 6.

A transmitter can determine the present SAR value of RF energy at one or more particular locations of the transmission field using one or more sampling or measurement techniques. In some embodiments, the SAR values within the transmission field are measured and pre-determined by SAR value measurement equipment. In some implementations, the transmitter may be preloaded with values, tables, and/or algorithms that indicate for the transmitter which distance ranges in the transmission field are likely to exceed to a pre-stored SAR threshold value. In some implementations, the transmitter may be preloaded with values, tables, and/or algorithms that indicate for the transmitter which radiation profiles within the transmission field are likely to exceed to a pre-stored SAR threshold value. For example, a lookup table may indicate that the SAR value for a volume of space (V) located some distance (D) from the transmitter receiving a number of power waves (P) having a particular frequency (F). One skilled in the art, upon reading the present disclosure, will appreciate that there are any number of potential calculations, which may use any number of variables, to determine the SAR value of RF energy at a particular locations, each of which is within the scope of this disclosure.

Moreover, a transmitter may apply the SAR values identified for particular locations in various ways when generating, transmitting, or adjusting the radiation profile. An SAR value at or below 1.6 W/kg, is in compliance with the FCC (Federal Communications Commission) SAR requirement in the United States. A SAR value at or below 2 W/kg is in compliance with the IEC (International Electrotechnical Commission) SAR requirement in the European Union. In some embodiments, the SAR values may be measured and used by the transmitter to maintain a constant energy level throughout the transmission field, where the energy level is both safely below a SAR threshold value but still contains enough RF energy for the receivers to effectively convert into electrical power that is sufficient to power an associated device, and/or charge a battery. In some embodiments, the transmitter may proactively modulate the radiation profiles based upon the energy expected to result from newly formed radiation profiles based upon the predetermined SAR threshold values. For example, after determining how to generate or adjust the radiation profiles, but prior to actually transmitting the power, the transmitter may determine whether the radiation profiles to be generated will result in RF energy accumulation at a particular location that either satisfies or fails the SAR threshold. Additionally or alternatively, in some embodiments, the transmitter may actively monitor the transmission field to reactively adjust power waves transmitted to or through a particular location when the transmitter determines that the power waves passing through or accumulating at the particular location fail the SAR threshold. Where the transmitter is configured to proactively and reactively adjust the power radiation profile, with the goal of maintaining a continuous power level throughout the transmission field, the transmitter may be configured to proactively adjust the power radiation profile to be transmitted to a particular location to be certain the power waves will satisfy the SAR threshold, but may also continuously poll the SAR values at locations throughout the transmission field (e.g., using one or more sensors configured to measure such SAR values) to determine whether the SAR values for power waves accumulating at or passing through particular locations unexpectedly fail the SAR threshold.

In some embodiments, control systems of transmitters adhere to electromagnetic field (EMF) exposure protection standards for human subjects. Maximum exposure limits are defined by US and European standards in terms of power density limits and electric field limits (as well as magnetic field limits). These include, for example, limits established by the Federal Communications Commission (FCC) for MPE, and limits established by European regulators for radiation exposure. Limits established by the FCC for MPE are codified at 47 CFR § 1.1310. For electromagnetic field (EMF) frequencies in the microwave range, power density can be used to express an intensity of exposure. Power density is defined as power per unit area. For example, power density can be commonly expressed in terms of watts per square meter (W/m2), milliwatts per square centimeter (mW/cm2), or microwatts per square centimeter (μW/cm2).

In some embodiments, and as a non-limiting example, the wireless-power transmission systems disclosed herein comply with FCC Part § 18.107 requirement which specifies “Industrial, scientific, and medical (ISM) equipment. Equipment or appliances designed to generate and use locally RF energy for industrial, scientific, medical, domestic or similar purposes, excluding applications in the field of telecommunication.” In some embodiments, the wireless-power transmission systems disclosed herein comply with ITU (International Telecommunication Union) Radio Regulations which specifies “industrial, scientific and medical (ISM) applications (of radio frequency energy): Operation of equipment or appliances designed to generate and use locally radio frequency energy for industrial, scientific, medical, domestic or similar purposes, excluding applications in the field of telecommunications.” In some embodiments, the wireless-power transmission systems disclosed herein comply with other requirements such as requirements codified under EN 62311: 2008, IEC/EN 662209-2: 2010, and IEC/EN 62479: 2010.

In some embodiments, the present systems and methods for wireless-power transmission incorporate various safety techniques to ensure that human occupants in or near a transmission field are not exposed to EMF energy near or above regulatory limits or other nominal limits. One safety method is to include a margin of error (e.g., about 10% to 20%) beyond the nominal limits, so that human subjects are not exposed to power levels at or near the EMF exposure limits. A second safety method can provide staged protection measures, such as reduction or termination of wireless-power transmission if humans (and in some embodiments, other living beings or sensitive objects) move toward a radiation area with power density levels exceeding EMF exposure limits. In some embodiments, these safety methods (and others) are programmed into a memory of the transmitter (e.g., memory 706) to allow the transmitter to execute such programs and implement these safety methods. In some embodiments, the safety methods are implemented by using sensors to detect a foreign object within the transmission field.

FIG. 6 is a block diagram of an RF wireless-power transmission system 650 in accordance with some embodiments. In some embodiments, the RF wireless-power transmission system 650 includes an RF power transmitter 100 (also referred to herein as a near-field (NF) charging system 100), NF power transmitter 100, RF power transmitter 100). In some embodiments, the RF power transmitter 100 includes an RF power transmitter integrated circuit 660 (described in more detail below). In some embodiments, the RF power transmitter 100 includes one or more communications components 704 (e.g., wireless communication components, such as WI-FI or BLUETOOTH radios). In some embodiments, the RF power transmitter 100 also connects to one or more power amplifier units 608-1, . . . 608-n to control operation of the one or more power amplifier units when they drive external power-transfer elements (e.g., power-transfer elements, such as transmission antennas 710-1 to 710-n). In some embodiments antennas 710-1 to 710-n are placed near elements 711-A to 711-n (also referred to as non-radiating elements 202A and 202B, and/or flipped-non-radiating elements 202A-1 and 202B-1 depending on the circumstances and desired radiation distributions to be produced by the corresponding radiating elements), respectively. In some embodiments, a single power amplifier, e.g. 608-1 is controlling one antenna 710-1. In some embodiments, RF power is controlled and modulated at the RF power transmitter 100 via switch circuitry as to enable the RF wireless-power transmission system to send RF power to one or more wireless receiving devices via the TX antenna array 710. In some embodiments, a single power amplifier, e.g. 608-n is controlling multiple antennas 710-m to 710-n through multiple splitters (610-1 to 610-n) and multiple switches (612-1 to 612-n).

In some embodiments, the communication component(s) 704 enable communication between the RF power transmitter 100 and one or more communication networks. In some embodiments, the communication component(s) 704 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document. In some instances, the communication component(s) 704 are not able to communicate with wireless-power receivers for various reasons, e.g., because there is no power available for the communication component(s) to use for the transmission of data signals or because the wireless-power receiver itself does not actually include any communication component of its own. As such, in some optional embodiments, near-field power transmitters described herein are still able to uniquely identify different types of devices and, when a wireless-power receiver is detected, figure out if that wireless-power receiver is authorized to receive wireless-power. In some embodiments, a signature-signal receiving/generating circuits are used in identifying the receivers as described in more detail below and are also described in U.S. patent application Ser. No. 16/045,637, “Systems and Methods for Detecting Wireless Power Receivers and Other Objects at a Near-Field Charging Pad,” filed on Jul. 25, 2018, which is hereby incorporated by reference in its entirety.

FIG. 7 is a block diagram of the RF power transmitter integrated circuit 660 (the “RF IC”) in accordance with some embodiments. In some embodiments, the RF IC 660 includes a CPU subsystem 670, an external device control interface, an RF subsection for DC to RF power conversion, and analog and digital control interfaces interconnected via an interconnection component, such as a bus or interconnection fabric block 671. In some embodiments, the CPU subsystem 670 includes a microprocessor unit (CPU) 702 with related Read-Only-Memory (ROM) 672 for device program booting via a digital control interface, e.g. an I2C port, to an external FLASH containing the CPU executable code to be loaded into the CPU Subsystem Random Access Memory (RAM) 674 or executed directly from FLASH. In some embodiments, the CPU subsystem 670 also includes an encryption module or block 676 to authenticate and secure communication exchanges with external devices, such as wireless-power receivers that attempt to receive wirelessly delivered power from the RF power transmitter 100.

In some embodiments, the RF IC 660 also includes (or is in communication with) a power amplifier controller IC 661A (PA IC) that is responsible for controlling and managing operations of a power amplifier, including for reading measurements of impedance at various measurement points within the power amplifier. The PA IC 661A may be on the same integrated circuit at the RF IC 660, or may be on its own integrated circuit that is separate from (but still in communication with) the RF IC 660. In some embodiments, the PA IC 661A is on the same chip with one or more of the Power Amplifiers (PAs) 608. In some other embodiments, the PA IC 661A is on its own chip that is a separate chip from the Power Amplifiers (PAs) 608.

In some embodiments, executable instructions running on the CPU are used to manage operation of the RF power transmitter 100 and to control external devices through a control interface, e.g., SPI control interface 675, and the other analog and digital interfaces included in the RF power transmitter integrated circuit 660. In some embodiments, the CPU subsystem 670 also manages operation of the RF subsection of the RF power transmitter integrated circuit 660, which includes an RF local oscillator (LO) 677 and an RF transmitter (TX) 678. In some embodiments, the RF LO 677 is adjusted based on instructions from the CPU subsystem 670 and is thereby set to different desired frequencies of operation, while the RF TX converts, amplifies, modulates the RF output as desired to generate a viable RF power level.

In some embodiments, the RF power transmitter integrated circuit 660 provides the viable RF power level (e.g., via the RF TX 678) directly to the one or more power amplifiers 608 and does not use any beam-forming capabilities (e.g., bypasses/disables a beam-forming IC and/or any associated algorithms if phase-shifting is not required, such as when only a single antenna 710 is used to transmit power transmission signals to a wireless-power receiver). In some embodiments, the PA IC 661A regulates the functionality of the PAs 608 including adjusting the viable RF power level to the PAs 608.

In some embodiments, the RF power transmitter integrated circuit 660 provides the viable RF power level (e.g., via the RF TX 678) directly to the one or more power amplifiers 608 and does not use a beam-forming IC. In some embodiments, by not using beam-forming control, there is no active beam-forming control in the power transmission system. For example, in some embodiments, by eliminating the active beam-forming control, the relative phases of the power signals from different antennas are unaltered after transmission. In some embodiments, by eliminating the active beam-forming control, the phases of the power signals are not controlled and remain in a fixed or initial phase. In some embodiments, the PA IC 661A regulates the functionality of the PAs 608 including adjusting the viable RF power level to the PAs 608.

The components of the near-field charging system 100 are also used to ensure that power is transmitted safely. For example, Specific Absorption Rate (SAR) values and Electromagnetic Field (EMF) values can be used to help ensure safe transmission of wireless power. In some embodiments, the system 100 can determine the present SAR value of RF energy at one or more particular locations near the charging surfaces described herein using one or more sampling or measurement techniques. In some embodiments, the SAR values near the charging surfaces are measured and pre-determined by SAR value measurement equipment. In some implementations, the system 100 may be preloaded with values, tables, and/or algorithms that indicate for the system 100 which distance ranges are likely to exceed a pre-stored SAR threshold value. In some implementations, the system may be preloaded with values, tables, and/or algorithms that indicate for the system which radiation profiles near the charging surface are likely to exceed to a pre-stored SAR threshold value. For example, a lookup table may indicate that the SAR value for a volume of space (V) located some distance (D) from the system receiving a number of power waves (P) having a particular frequency (F). One skilled in the art, upon reading the present disclosure, will appreciate that there are any number of potential calculations, which may use any number of variables, to determine the SAR value of RF energy at a particular locations, each of which is within the scope of this disclosure.

A SAR value at or below 1.6 W/kg, is in compliance with the FCC (Federal Communications Commission) SAR requirement in the United States. A SAR value at or below 2 W/kg is in compliance with the IEC (International Electrotechnical Commission) SAR requirement in the European Union. In some embodiments, the SAR values may be measured and used by the system to maintain a constant energy level throughout the charging surfaces, where the energy level is both safely below a SAR threshold value but still contains enough RF energy for the receivers to effectively convert into electrical power that is sufficient to power an associated device, and/or charge a battery. In some embodiments, the transmitter may proactively modulate the radiation profiles based upon the energy expected to result from newly formed radiation profiles based upon the predetermined SAR threshold values. For example, after determining how to generate or adjust the radiation profiles, but prior to actually transmitting the power, the system may determine whether the radiation profiles to be generated will result in RF energy accumulation at a particular location that either satisfies or fails the SAR threshold. Additionally or alternatively, in some embodiments, the system may actively monitor the charging surfaces to reactively adjust power waves transmitted to or through a particular location when the transmitter determines that the power waves passing through or accumulating at the particular location fail the SAR threshold. Where the system is configured to proactively and reactively adjust the power radiation profile, with the goal of maintaining a continuous power level throughout the charging surface, the system may be configured to proactively adjust the power radiation profile to be transmitted to a particular location to be certain the power waves will satisfy the SAR threshold, but may also continuously poll the SAR values at locations near the charging surfaces (e.g., using one or more sensors configured to measure such SAR values) to determine whether the SAR values for power waves accumulating at or passing through particular locations unexpectedly fail the SAR threshold.

In some embodiments, the system 100 described herein also adheres to electromagnetic field (EMF) exposure protection standards for human subjects. Maximum exposure limits are defined by US and European standards in terms of power density limits and electric field limits (as well as magnetic field limits). These include, for example, limits established by the Federal Communications Commission (FCC) for MPE, and limits established by European regulators for radiation exposure. Limits established by the FCC for MPE are codified at 47 CFR § 1.1310. For electromagnetic field (EMF) frequencies in the microwave range, power density can be used to express an intensity of exposure. Power density is defined as power per unit area. For example, power density can be commonly expressed in terms of watts per square meter (W/m2), milliwatts per square centimeter (mW/cm2), or microwatts per square centimeter (μW/cm2).

In some embodiments, and as a non-limiting example, the system disclosed herein complies with FCC Part § 18.107 requirement which specifies “Industrial, scientific, and medical (ISM) equipment. Equipment or appliances designed to generate and use locally RF energy for industrial, scientific, medical, domestic or similar purposes, excluding applications in the field of telecommunication.” In some embodiments, the system disclosed herein complies with ITU (International Telecommunication Union) Radio Regulations which specifies “industrial, scientific and medical (ISM) applications (of radio frequency energy): Operation of equipment or appliances designed to generate and use locally radio frequency energy for industrial, scientific, medical, domestic or similar purposes, excluding applications in the field of telecommunications.” In some embodiments, the system 100 disclosed herein comply with other requirements such as requirements codified under EN 62311: 2008, IEC/EN 662209-2: 2010, and IEC/EN 62479: 2010.

In some embodiments, the present systems and methods for wireless-power transmission incorporate various safety techniques to ensure that human occupants in or near a transmission field are not exposed to EMF energy near or above regulatory limits or other nominal limits. One safety method is to include a margin of error (e.g., about 10% to 20%) beyond the nominal limits, so that human subjects are not exposed to power levels at or near the EMF exposure limits. A second safety method can provide staged protection measures, such as reduction or termination of wireless-power transmission if humans (and in some embodiments, other living beings or sensitive objects) move toward a radiation area with power density levels exceeding EMF exposure limits. In some embodiments, these safety methods (and others) are programmed into a memory of the transmitter (not shown) to allow the transmitter to execute such programs and implement these safety methods. In some embodiments, the safety methods are implemented by using sensors to detect a foreign object within the transmission field.

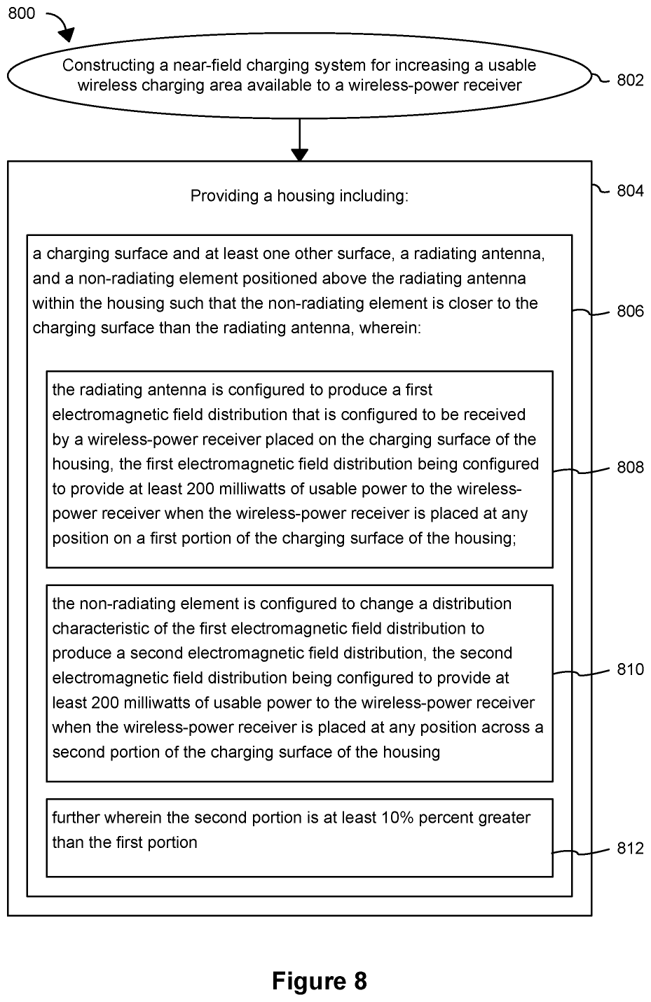

FIG. 8 shows a flow diagram of a method of constructing a near-field charging system, in accordance with some embodiments. In some embodiments, the method of FIG. 8 is performed by a manufacturer of near-field charging systems, or by a manufacturer of components such systems.

Specifically, FIG. 8 shows a method 800 of constructing (802) a near-field charging system for increasing a usable wireless charging area available to a wireless-power receiver. The method 800 includes providing a housing of the near-field charging system (804). The housing that is provided in operation 804 includes a charging surface and at least one other surface (806). In some embodiments, the charging surface is a top surface of the housing, such as top surface of the housing 104 depicted in FIGS. 1 and 2. The top surface includes one or more charging surfaces (e.g., charging surfaces 106A and 106B, FIGS. 1 and 2) at which a wireless-power receiver is placed to allow that receiver to receive electromagnetic energy that it can then convert into usable power for charging or powering of an electronic device coupled to the wireless-power receiver. The other surfaces can be surfaces that allow for encasing the radiating antenna (e.g., radiating antennas 204A and 204B) and the non-radiating elements (e.g., parasitic element) 202A, 202B, 202A-1, and 202B-1, but these other surfaces are not configured to allow for the wireless-power receiver to receive the electromagnetic energy. Stated another way, the radiating elements 204A and 204B and parasitic element 202A, 202B, 202A-1, and 202B-1, in some embodiments, produce electromagnetic energy that is enhanced on the charging surface, and is not configured to be available on the other surfaces).

Further, the housing that is provided in operation 804 also includes a radiating antenna (806). In some embodiments, the radiating antenna is made from a conductive material such as copper, or any other suitable radiative material. The radiating antenna is coupled to a feed line that provides an RF signal to the radiating antenna. In contrast, a non-radiating element (also referred to as a parasitic element, and discussed below) is not coupled to a feeding line. The housing also includes the non-radiating element positioned above the radiating antenna within the housing such that the non-radiating element is closer to the charging surface than the radiating antenna (806) (e.g., the non-radiating element is a parasitic element such as a conductive metal patch, an example of which is depicted in FIGS. 2, 4A, and 4B (e.g., non-radiating element 202A), and which is depicted as positioned on top of the radiating antenna 204A. In some embodiments, the parasitic element has a same shape as the radiating antenna, as is shown in FIGS. 2, 4A, and 4B).

The radiating antenna is configured to produce a first electromagnetic field distribution that is configured to be received by a wireless-power receiver placed on the charging surface (e.g., charging surfaces 106A and 106B in FIGS. 2, 4A, and 4B, which can be surfaces of the housing (e.g., housing 104) on which receiving devices may be placed. In some embodiments or circumstances, the first electromagnetic field distribution can be configured to provide at least 200 and/or a minimum of milliwatts of usable power (e.g., usable power is energy that is rectified and converted to the correct requirements for whatever type of device is receiving power or charge from the wireless-power receiver) to the wireless-power receiver when the wireless-power receiver is placed at any position on a first portion of the charging surface of the housing (808).

The non-radiating element, when placed in a position above the radiating element, is configured to change a distribution characteristic of the first electromagnetic field distribution to produce a second electromagnetic field distribution (which is distinct from the first electromagnetic field distribution), the second electromagnetic field distribution being configured to provide at least 200 milliwatts of usable power to the wireless-power receiver when the wireless-power receiver is placed at any position across a second portion of the charging surface of the housing (810).

In some circumstances, examples of the change to the distribution characteristic include, as non-limiting examples, changes to e-field distribution to lower peaks and/or valleys. To illustrate this in one example, attention is directed to FIGS. 3A and 3B. A comparison of the electric field distribution plots shown in FIG. 3A (representing the electromagnetic field distribution of the radiating antenna when the parasitic element is not present, i.e., the first electromagnetic field distribution) and FIG. 3B (representing the electromagnetic field distribution of the radiating antenna when the parasitic element is present, i.e., the second electromagnetic field distribution) shows this change in the distribution characteristics that occurs when the non-radiating element is used to alter the electromagnetic field distribution of the radiating antenna.

The second portion can be at least 10% percent greater in size than the first portion (812). As one example, the first portion of the charging surface of the housing covers an area that includes 70% of the surface area of the charging surface (e.g., as shown in FIG. 1, the dashed-line outlines labeled 110A and 110B each represent approximately 70% of the surface area of the charging surface), and the second portion of the charging surface of the housing covers an area that includes at least 80% of the surface area of the charging surface (e.g., as shown in FIG. 1, the dashed-line outlines labeled 112A and 112B each represent approximately 80% of the surface area of the charging surface). In some embodiments, the second portion covers an area of the charging surface that is at least 10% percent larger in size than the first portion. In some embodiments, the percentage can be any integer or fractional value falling between the range of 10% to 30% (e.g., 11%, 11.5%, 18%, 19.1%, 20.5, 25, etc.)

In some embodiments of the method 800, the second electromagnetic field distribution is configured to provide at least 220 milliwatts of usable power to the wireless-power receiver when the wireless-power receiver is placed at any position across the second portion of the charging surface of the housing. In other words, amount of usable power available across the second portion of the charging surface can be increased from 200 to 220 milliwatts in order to provide an amount of usable power to a receiving device with a higher power requirement. In some embodiments, 220 milliwatts provides enough power to charge one or more wireless earbuds or hearing aids.

In some embodiments of the near-field charging system, the second electromagnetic field distribution is configured to provide at least 1 watt of usable power to the wireless-power receiver when the wireless-power receiver is placed at any position across a second portion of the charging surface of the housing. In other words, amount of usable power available across the second portion of the charging surface can be increased from 200 milliwatts to 1 watt in order to provide an amount of usable power to a receiving device with a higher power requirement. In some embodiments, 1 watt provides enough power to charge a wearable electronic device such as a smartwatch.

In some embodiments of the near-field charging system, the second electromagnetic field distribution is configured to provide at least 5 watts of usable power to the wireless-power receiver when the wireless-power receiver is placed at any position across a second portion of the charging surface of the housing. In other words, amount of usable power available across the second portion of the charging surface can be increased from 200 milliwatts to 5 watts in order to provide an amount of usable power to a receiving device with a higher power requirement. In some embodiments, 5 watts provides enough power to charge a small electronic device such as a smartphone.

In some embodiments of the near-field charging system, the first portion of the charging surface of the housing covers an area that includes 70% of the surface area of the charging surface. For example, FIGS. 3B, 4A, and 4B show charging surfaces that cover 70% of the charging surface.

In some embodiments of the near-field charging system, the radiating antenna is configured to produce a first reflection coefficient, and positioning the non-radiating element above the radiating antenna within the housing such that the non-radiating element is closer to the charging surface than the radiating antenna, the radiating antenna is configured to produce a second reflection coefficient that is 75% less than the first reflection coefficient, thereby causing a reduction in return losses for the near-field charging system. In some embodiments, while the reflection coefficient becomes more invariant with the movement of the wireless receiver devices on the charging surfaces of the near-field charging system, the charging surfaces uniformity increases. In some embodiments, the second reflection coefficient is up to 20% less than the first reflection coefficient.

In some embodiments, the addition of the non-radiating element (e.g., the parasitic element) results in a reflection coefficient of the near field charging system's radiating antennas becoming more stable and far less sensitive to the relative placement and/or location of the receiver device (e.g., where the wireless-power receiver is coupled to the audio output device (e.g., a hearing aid, wireless headphones, or an earbud)). Therefore, as the receiver is moved over the surface of the transmitter antenna, the reflection coefficient does not vary as much, the return loss at the radiating antenna feed can be greatly reduced, and the power transferred to the radiating antenna is uniform and stable. This is not, however, the case for the radiating antennas without non-radiating elements placed proximate thereto. For example, when the near field charging system does not have a non-radiating element, reflection coefficient varies between −5 dB to −18 dB as the position of the receiver is varied within the charging area. This, in turn, leads to poor coupling of power in some areas where the reflection coefficient (and return loss) is high. On the other hand, when the parasitic element is added, in some embodiments, the reflection coefficient varies between −13 dB to −16 dB as the position of the receiver is varied within the charging area. In most circumstances, this is a desired result because the reflection coefficient (and return loss) is always low at the antenna feed. In some embodiments, reflection coefficient is (and in some embodiments always) less than −10 dB. Therefore, the power transferred into the radiating antenna can be uniform and stable, and is not dependent on the location of the receiver antenna.

In some embodiments of the near-field charging system, the second electromagnetic field distribution of the near-field charging system is configured to provide more than 200 milliWatts. In some embodiments, this amount of usable power is adjusted based on the requirements of the receiving device (i.e., the electronic device that is coupled to the wireless-power receiver). In some embodiments, 1 watt emitted by the system 100 can be an appropriate amount of power to charge a single wireless headphone. In some embodiments, 200 watts emitted by the near-field charging system may be an appropriate amount of power to charge a laptop device. In some embodiments, placement of the parasitic element above the radiating antenna within the housing thus causes a flattening of the resulting electromagnetic field distribution (the referenced second electromagnetic field distribution referred to herein) produced by the radiating antennas of the near-field charging system 100, such that more usable charging locations are available to the wireless-power receiver on the charging surface (e.g., locations at which the receiver is able to receive at least 200 milliWatts (or some other value depending on the circumstances and configuration of the system) of usable power), but the locations at which more than 250 milliWatts (or some other value depending on the circumstances and configuration of the system) of usable power could be received by the wireless-power receiver are reduced. Thus, in such embodiments, more usable charging locations are available overall (e.g., as depicted and explained with reference to FIG. 2, cold zone locations are reduced on the charging surfaces), but less locations of higher amounts of usable power are made available to the wireless-power receiver. Such an occurrence is evidenced by comparing FIG. 3A (which shows the electromagnetic field distribution without the non-radiating element) to FIG. 3B (which shows the electromagnetic field distribution with the non-radiating element)). In other words, in some embodiments, uniformity of charging across the charging surfaces is the most important goal, and therefore sacrificing higher power level areas to achieve uniformity is desirable.

In some embodiments, the charging surface of the near-field charging system has a depression (e.g., depressions 106A-1 and 106B-1 in FIG. 1) that is configured to receive and partially surround an audio output device, and where the wireless-power receiver is coupled to the audio output device (e.g., a hearing aid, wireless headphones, or an earbud), and the wireless power receiver is configured to provide at least 200 milliwatts of usable power to the audio output device for charging or powering purposes.

In some embodiments, the audio output device is a single in-ear audio output device (e.g., a wireless earbud or audio output device (indicated by 102A and 102B in FIG. 1), or a hearing aid, etc.).

In some embodiments, the radiating antenna has a shape (e.g., a PIFA antenna with a radiator substantially in the shape of the letter ‘c,’ similar to the shape depicted for radiating elements in FIGS. 2, 4A, and 4B), and the radiating antenna is oriented to have a first orientation within the housing. In embodiments in which the charging surface is a planar surface, the first orientation can be such that the largest surface of the radiating antenna is substantially coplanar with (e.g., within +/−5 degrees of coplanar with) the largest surface of the charging surface, similar to the orientation shown in FIG. 2 and FIG. 4A.); and the non-radiating element has the shape (e.g., a substantially identical shape as the radiating antenna, as shown in FIGS. 2 and 4A) and the first orientation within the housing. In some embodiments, the non-radiating element has a surface area that varies by approximately 10% relative to a surface area of the radiating antenna (e.g., the non-radiating element is either larger or smaller than the radiating antenna by 10% of its surface area).

In some embodiments, the radiating antenna has a shape (e.g., a PIFA antenna with a radiator having a ‘c’ shaped design, similar to the shape shown by radiating elements in FIGS. 2, 4A, and 4B) and the radiating antenna is oriented to have the first orientation (described above) within the housing; and the non-radiating element has: the same shape (e.g., an identical shape as the radiating antenna, as shown in FIG. 4A); and a second orientation within the housing that is different from the first orientation (as shown in FIG. 4B).

In some embodiments, the radiating antenna is connected to a power feed line (as shown by power feed lines 210A and 210B in FIG. 2), and the non-radiating element (e.g., the non-radiating element is a parasitic element) is not connected to a power feed line (as shown FIG. 2).

In some embodiments, a non-conducting material is placed between the radiating antenna and the non-radiating element, and the non-conducting material electrically isolates the radiating antenna from the non-radiating element (as shown by circuit board 206 in FIGS. 2, 4A, and 4B). In some embodiments, rather than use a circuit board, a dielectric can be utilized as the non-conducting material, and the radiating antennas and non-radiating elements can be in the form of stamped metal components (instead of being printed elements on a circuit board).

In some embodiments, the radiating antenna and the non-radiating element both have a same antenna design selected from the group consisting of: a PIFA antenna design, a patch antenna design, and a dipole antenna design.

In some embodiments, the non-radiating element is positioned at least 1 millimeter above the radiating antenna within the housing such that the non-radiating element is closer to the charging surface than the radiating antenna (e.g., as shown in FIG. 1 where the circuit board 206 is 1 millimeter thick). In some embodiments, the non-radiating element is positioned at least 1.5 millimeter above the radiating antenna within the housing such that the non-radiating element is closer to the charging surface than the radiating antenna. In some embodiments, the non-radiating elements are floating exactly on top of the radiating element with a one-millimeter layer of dielectric in between. In some embodiments, there is no conductive material connecting the non-radiating elements with the radiating antennas; in other words, there is no electrical connection between the radiating antennas and the non-radiating elements.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., memory 206, 256) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory optionally includes one or more storage devices remotely located from the CPU(s) (e.g., processor(s)). Memory, or alternatively the non-volatile memory device(s) within the memory, comprises a non-transitory computer readable storage medium.

Stored on any one of the machine readable medium (media), features of the present invention can be incorporated in software and/or firmware for controlling the hardware of a processing system (such as the components associated with the transmitters 100 and/or receivers 104), and for enabling a processing system to interact with other mechanisms utilizing the results of the present invention. Such software or firmware may include, but is not limited to, application code, device drivers, operating systems, and execution environments/containers.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. (canceled)

2. A near-field charging system for increasing a usable wireless charging area available to a wireless-power receiver, the near-field charging system comprising:
a wireless-power receiver and
a wireless-power transmitter including:
a charging surface,
a radiating antenna, and
a non-radiating element positioned above the radiating antenna within the wireless-power transmitter such that the non-radiating element is closer to the charging surface than the radiating antenna,
wherein:
the radiating antenna is configured to produce a first electromagnetic field distribution that is configured to be received by the wireless-power receiver placed on the charging surface of the wireless-power transmitter, the first electromagnetic field distribution being configured to provide at least 200 milliwatts of usable power to the wireless-power receiver when the wireless-power receiver is placed at any position on a first portion of the charging surface of the wireless-power transmitter;
the non-radiating element is configured to change a distribution characteristic of the first electromagnetic field distribution to produce a second electromagnetic field distribution, the second electromagnetic field distribution being configured to provide at least 200 milliwatts of usable power to the wireless-power receiver when the wireless-power receiver is placed at any position across a second portion of the charging surface of the wireless-power transmitter, further wherein the second portion is at least 10% percent greater than the first portion.

3. The near-field charging system of claim 1, the second electromagnetic field distribution being configured to provide at least 220 milliwatts of usable power to the wireless-power receiver when the wireless-power receiver is placed at any position across the second portion of the charging surface of the wireless-power transmitter.

4. The near-field charging system of claim 1, the second electromagnetic field distribution being configured to provide at least 1 watt of usable power to the wireless-power receiver when the wireless-power receiver is placed at any position across the second portion of the charging surface of the wireless-power transmitter.

5. The near-field charging system of claim 1, the second electromagnetic field distribution being configured to provide at least 5 watts of usable power to the wireless-power receiver when the wireless-power receiver is placed at any position across the second portion of the charging surface of the wireless-power transmitter.

6. The near-field charging system of claim 1, wherein the first portion of the charging surface of the wireless-power transmitter covers an area that includes 70% of the surface area of the charging surface.

7. The near-field charging system of claim 1, wherein:
the radiating antenna is configured to produce a first reflection coefficient, and
positioning the non-radiating element above the radiating antenna within the wireless-power transmitter such that the non-radiating element is closer to the charging surface than the radiating antenna, the radiating antenna is configured to produce a second reflection coefficient that is 12% less than the first reflection coefficient, thereby causing a reduction in return losses for the near-field charging system.

8. The near-field charging system of claim 6, wherein the second reflection coefficient varies between −13 dB and −16 dB.

9. The near-field charging system of claim 6, wherein the second reflection coefficient is less than −10 dB.

10. The near-field charging system of claim 1, wherein the second electromagnetic field distribution is configured to provide more than 200 milliwatts of usable power to the wireless-power receiver at fewer locations on the charging surface of the wireless-power transmitter relative to the first electromagnetic field distribution.

11. The near-field charging system of claim 1, wherein the charging surface has a depression configured to receive and partially house an audio output device, and further wherein the wireless-power receiver is coupled to the audio output device, and the wireless power receiver is configured to provide the at least 200 milliwatts of usable power to the audio output device for charging or powering purposes.

12. The near-field charging system of claim 11, wherein the audio output device is a single in-ear audio output device.

13. The near-field charging system of claim 1, wherein:
the radiating antenna has a shape, and the radiating antenna is oriented to have a first orientation within the wireless-power transmitter; and
the non-radiating element has the shape and the first orientation within the wireless-power transmitter.

14. The near-field charging system of claim 1, wherein:
the radiating antenna has a shape and the radiating antenna is oriented to have a first orientation within the housing;
the non-radiating element has:
the same shape; and
a second orientation within the housing that is different from the first orientation.

15. The near-field charging system of claim 1, wherein the radiating antenna is connected to a power feed line, and the non-radiating element is not connected to a power feed line.

16. The near-field charging system of claim 1, wherein a non-conducting material is placed between the radiating antenna and the non-radiating element, wherein the non-conducting material electrically isolates the radiating antenna from the non-radiating element.

17. The near-field charging system of claim 1, wherein the radiating antenna and the non-radiating element both have a same radiating antenna design selected from the group consisting of: a PIFA antenna design, a patch antenna design, and a dipole antenna design.

18. The near-field charging system of claim 1, wherein the non-radiating element is positioned at least 1 millimeter above the radiating antenna within the wireless-power transmitter such that the non-radiating element is closer to the charging surface than the radiating antenna.

19. A non-transitory computer readable storage medium including instructions that, when executed by a computing device communicatively coupled to a wireless-power transmitter, cause the wireless-power transmitter to:
cause production, via a radiating antenna of a wireless-power transmitter, of a first electromagnetic field distribution to be received by a wireless-power receiver placed on a charging surface of the wireless-power transmitter, wherein the first electromagnetic field distribution provides at least 200 milliwatts of usable power to the wireless-power receiver when the wireless-power receiver is placed at any position on a first portion of the charging surface of the wireless-power transmitter, and
cause a change, via a non-radiating element of the wireless-power transmitter, of a distribution characteristic of the first electromagnetic field distribution to produce a second electromagnetic field distribution, wherein the second electromagnetic field distribution provides at least 200 milliwatts of usable power to the wireless-power receiver when the wireless-power receiver is placed at any position across a second portion of the charging surface of the wireless-power transmitter,
wherein:
the second portion is at least 10% percent greater than the first portion, and
the non-radiating element is positioned above the radiating antenna within the wireless-power transmitter such that the non-radiating element is closer to the charging surface than the radiating antenna.

20. The non-transitory computer readable storage medium of claim 18, the instructions further causing the wireless-power transmitter to:
cause production, via the radiating antenna, of a first reflection coefficient, and
when the non-radiating element is positioned above the radiating antenna within the wireless-power transmitter such that the non-radiating element is closer to the charging surface than the radiating antenna, cause production, via the radiating antenna, of a second reflection coefficient, wherein:
the second reflection coefficient is 12% less than the first reflection coefficient, thereby causing a reduction in return losses between the wireless-power transmitter and the wireless-power receiver.

21. The non-transitory computer readable storage medium of claim 18, wherein:
the radiating antenna has a shape, and the radiating antenna is oriented to have a first orientation within the wireless-power transmitter; and
the non-radiating element has the shape and the first orientation within the wireless-power transmitter.
